(19) United States
(12) Patent Application Publication
(10) Pub. No.: US 2016/0303843 A1
(43) Pub. Date: Oct. 20, 2016

(54) POROUS ADHESIVE FILM, METHOD OF MANUFACTURING THE SAME, AND DISPLAY DEVICE INCLUDING THE SAME

(71) Applicant: SAMSUNG DISPLAY CO., LTD., Yongin-si (KR)

(72) Inventors: Cheol Jang, Uiwang-si (KR); Jinkoo Kang, Ansan-si (KR)

(21) Appl. No.: 14/856,476

(22) Filed: Sep. 16, 2015

(30) Foreign Application Priority Data
Apr. 16, 2015 (KR) 10-2015-0053540

(51) Int. Cl. B32B 37/26; C09J 5/08; C09J 7/02; B32B 7/12; B32B 37/12

(52) U.S. Cl. CPC B32B 37/26; B32B 7/12; B32B 37/1284; C09J 7/0207; C09J 5/08; B32B 2457/206; B32B 2037/268; B32B 2305/026; C09J 2201/606; C09J 2203/326

(57) ABSTRACT

A porous adhesive film and a display device manufactured using the same are disclosed. The porous adhesive film includes: a porous adhesive sheet having a pore; an adhesive layer including an adhesive in the pore; and a release film disposed on at least a surface of the adhesive layer. The porous adhesive film may reduce deformation of the adhesive layer and displacement of the adhesion position of the adhesive layer.

### CROSS-REFERENCE TO RELATED APPLICATION

This application claims priority to and the benefit of Korean Patent Application No. 10-2015-0053540, filed in the Korean Intellectual Property Office (KIPO) on Apr. 16, 2015, the entire content of which is incorporated herein by reference.

### BACKGROUND

1. Field

Embodiments of the present disclosure relate to a porous adhesive film and a display device manufactured using the same.

2. Description of the Related Art

With the growing emphasis being placed on the significance of an electronic display industry, in which various items of information are visualized to be transmitted to users, as the modern industrialized society advances further into a highly developed information technology era, research on the development of display devices is being conducted in earnest. Such display devices are classified into self-emissive display devices such as cathode ray tube (“CRT”) devices, electroluminescent (“EL”) display devices, vacuum fluorescent display (“VFD”) devices, field emission display (“FED”) devices, or plasma display panel (“PDP”) devices; and non-self-emissive display devices such as liquid crystal display (“LCD”) devices.

For example, the significance of the display device as a visual information transmission medium is being widely acknowledged in the current information technology society. Thus, to continue to play a vital role in the industry in the upcoming years, features of the display device such as low power-consumption, lightweight, slimness, high picture quality, high transparency, and the like, should be addressed.

The display device includes a display panel that displays an image and a window that protects the display panel. In general, the display panel and the window are attached to one another by an adhesive layer. Such an adhesive layer may be formed of an adhesive composition, and studies are being carried out on various adhesive compositions to stably attach a display panel to a window.

It is to be understood that this background section is intended to provide useful background for understanding the technology related to the present disclosure and as such disclosed herein, the background section may include ideas, concepts or recognitions that were not part of what was known or appreciated by those skilled in the pertinent art prior to a corresponding effective filing date of the subject matter disclosed herein.

### SUMMARY

Aspects of embodiments of the present disclosure are directed to a display device capable of the repeated folding and unfolding thereof without concerns regarding modification of an adhesive layer or displacement of an adhesion position.

Aspects of embodiments of the present disclosure are also directed to a porous adhesive film having adhesion and rigidity and a method of manufacturing the same.

Aspects of embodiments of the present disclosure are also directed to a display device including a porous adhesive film having adhesion and rigidity.

According to an example embodiment, a porous adhesive film includes: an adhesive layer; and a release film on at least a surface of the adhesive layer, wherein the adhesive layer comprises: a porous adhesive sheet comprising a pore; and an adhesive filled in the pore.

The adhesive layer may have a shear modulus in a range of about 100 megapascals (MPa) to about 1000 MPa.

The pore may have a size in a range of about 0.6 micrometers (μm) to about 500 μm.

The adhesive may have a viscosity in a range of about 1 centipoise (cP) to about 5000 cP.

According to another example embodiment, a method of manufacturing a porous adhesive film, the method includes: preparing a lower release film; and disposing an adhesive layer on the lower release film, wherein the disposing of the adhesive layer includes: attaching a porous adhesive sheet comprising a pore to the lower release film; disposing an adhesive in the pore of the porous adhesive sheet; and curing the adhesive.

The method may further include disposing an upper release film on the adhesive layer to oppose the lower release film, prior to the curing of the adhesive.

The adhesive layer may have a shear modulus in a range of about 100 MPa to about 1000 MPa.

The pore may have a size in a range of about 0.5 μm to about 500 μm.

The adhesive may have a viscosity in a range of about 1 cP to about 5000 cP.

According to still another example embodiment, a display device includes: a display panel; a first adhesive layer on a first surface of the display panel; and a window on the first adhesive layer, wherein the first adhesive layer includes: a porous adhesive sheet comprising a pore; and an adhesive filled in the pore.

The display device may further include: a second adhesive layer on a second surface of the display panel; and a protection layer on the second adhesive layer.

The first adhesive layer may have a shear modulus in a range of about 100 MPa to about 1000 MPa.

The pore may have a size in a range of about 0.5 μm to about 500 μm.

The display panel may include an organic light emitting diode (“OLED”).

The foregoing is illustrative only and is not intended to be in any way limiting. In addition to the illustrative aspects, The foregoing is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and aspects of the present disclosure of disclosure will be more clearly understood from the following detailed description taken in conjunction with the accompanying drawings, in which:

FIG. 1 is a view illustrating a porous adhesive film according to an example embodiment;

FIG. 2 is a cross-sectional view illustrating a display device to which an adhesive layer is applied;

FIGS. 3 and 4 are cross-sectional views illustrating a functional film to which an adhesive layer is applied;

FIGS. 5A through 5D are views illustrating sequential processes of a method of manufacturing a porous adhesive film according to an example embodiment;

FIGS. 6A through 6D are views illustrating sequential processes of a method of manufacturing a porous adhesive film according to another example embodiment;

FIG. 7 is a cross-sectional view illustrating a display device including a porous adhesive film according to an example embodiment; and

FIG. 8 is a cross-sectional view illustrating a display device including a porous adhesive film according to another example embodiment.

### DETAILED DESCRIPTION

Advantages and features of embodiments of the present disclosure and embodiments of methods for achieving them will be made clear from example embodiments described below in more detail with reference to the accompanying drawings. The subject matter of the present disclosure may, however, be embodied in many different forms and should not be construed as being limited to the example embodiments set forth herein. Rather, these example embodiments are provided so that this disclosure will be thorough and complete, and will fully convey the scope of the present disclosure to those skilled in the art. The claimed embodiments of the present invention are defined by the scope of the claims, and equivalents thereof. Therefore, well-known constituent elements, operations and techniques are not described in more detail than necessary with respect to the example embodiments in order to prevent the described embodiments of the present disclosure from being obscurely interpreted. Like reference numerals refer to like elements throughout the specification.

The spatially relative terms “below”, “beneath”, “lower”, “above”, “upper”, and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device shown in the drawing is turned over, the device positioned “below” or “beneath” another device may be placed “above” another device. Accordingly, the spatially relative term “below” may include both the lower and upper positions. The device may also be oriented in the other direction, and thus the spatially relative terms may be interpreted differently depending on the orientations or the point of view.

All terminologies used herein are merely used to describe example embodiments of the inventive concept and may be modified according to the relevant art and the intention of a user. Therefore, the terms used herein should be interpreted as having a meaning that is consistent with their meanings in the context of the present disclosure, and is not intended to limit the invention. As used herein, the singular forms “a,” “an,” and “the” are intended to include the plural forms as well, unless the context clearly indicates otherwise. As used herein, the term “and/or” includes any and all combinations of one or more of the associated listed items. Expressions such as “at least one of,” when preceding a list of elements, modify the entire list of elements and do not modify the individual elements of the list. It will be further understood that the terms “comprises,” “comprising,” “includes” and/or “including,” when used in this specification, specify the presence of the stated features, integers, acts, operations, elements, and/or components, but do not preclude the presence or addition of one or more other features, integers, acts, operations, elements, components, and/or groups thereof.

A porous adhesive film according to an example embodiment may include: an adhesive layer; and a release film disposed on at least a surface of the adhesive layer. The adhesive layer may include a porous adhesive sheet having a pore; and an adhesive in (or filled in) the pore.

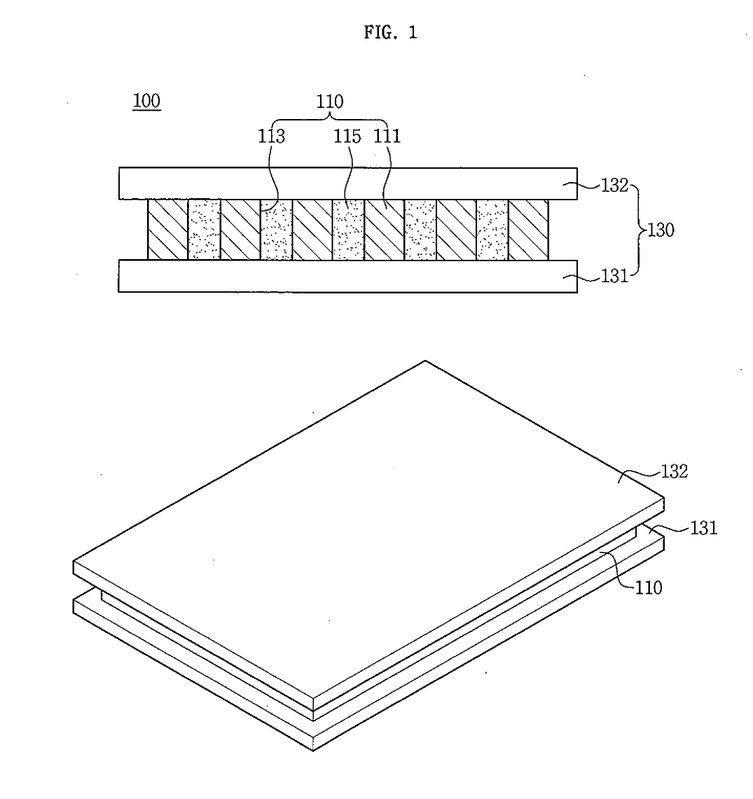

Hereinafter, a porous adhesive film 100 according to an example embodiment will be described with reference to FIG. 1.

FIG. 1 is a view illustrating the porous adhesive film 100 according to the example embodiment.

Referring to FIG. 1, the porous adhesive film 100 according to the example embodiment may include a lower release film 131, an upper release film 132 opposing (facing) the lower release film 131, and an adhesive layer 110 interposed between the upper release film 132 and the lower release film 131.

The upper release film 132 and the lower release film 131 may serve to temporarily protect an adhesive surface of the adhesive layer 110 against contamination by dust, debris, moisture, and other contaminants.

The upper release film 132 and the lower release film 131 may include a plastic film formed of the following materials: polyimide, polyethyleneterephthalate (PET), poly ethylene naphthalate (PEN), polyether sulfone (PES), nylon, poly tetra fluoro ethylene (PTFE), polyetherether ketone (PEEK), polycarbonate, and/or polyacrylate.

The upper release film 132 and the lower release film 131 may serve as a type (or kind) of substrate. When a completed porous adhesive film is attached to a display device, a release film 130, which includes the lower release film 131 and the upper release film 132, may be removed. In some embodiments, in a case in which the release film 130 is formed of a transmissive material, the release film 130 may be attached to a display device, along with a porous adhesive film that is attached to the display device.

The adhesive layer 110 according to the example embodiment may include a porous adhesive sheet 111 having a pore 113; and an adhesive 115 in (or filled in) the pore 113.

For example, the porous adhesive sheet 111 may have a vertical shape (e.g., a flat or sheet shape), and the pore 113 may have a size (a pore size) in a range of about 0.5 micrometers (μm) to about 500 μm. The adhesive 115 may be a curable liquid adhesive (hereinafter, also referred to as “curable liquid adhesive”), and may have a viscosity in a range of, for example, about 1 centipoise (cP) to about 5000 cP.

Other pressure sensitive adhesives (“PSA”) form a bond (an adhesive interaction) by a molecular interaction based on the van der Waals force, or the like. On the other hand, the curable liquid adhesive 115 of embodiments of the present disclosure may be cured by ultraviolet (“UV”) light or heat to thereby form a mechanical interlocking between the adhesive layer 110 and an upper adhesive surface of the upper release film 132 thereabove and a lower adhesive surface of the lower release film 131 therebelow.

The curable liquid adhesive 115 which is solidified in the pore 113 may serve to maintain a shape of the adhesive layer 110 as does steel in a steel-reinforced concrete. Accordingly, a mechanical anchoring between the upper and lower adhesive surfaces of the release film 130 and the adhesive layer 110 may be formed, and thereby deformation of the adhesive layer 110 such as a shear deformation may be prevented (or a likelihood or amount of such deformation may be reduced) even when an external force is applied thereto.

The adhesive layer 110 may have a shear modulus in a range of about 100 megapascals (MPa) to about 1000 MPa.

The adhesive layer 110 may have suitable adhesion and rigidity so as to bond a display panel, a window, a polarizing film and/or a touch film to one another.

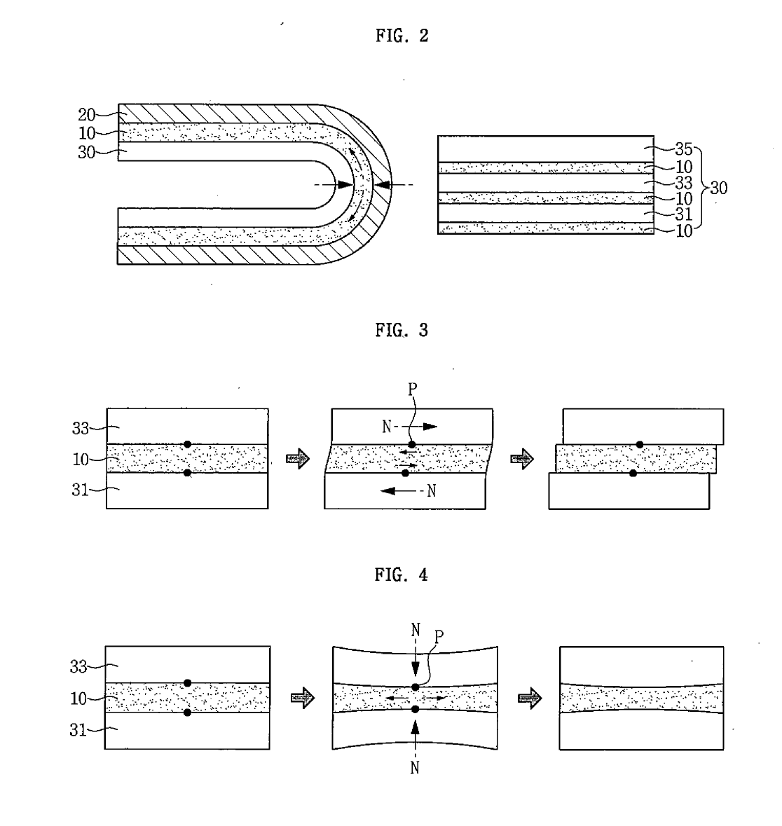

A description pertaining to effects of preventing or reducing modification of the adhesive and displacement of the adhesion position that may be achieved in an example embodiment will be provided with reference to FIGS. 2 through 4.

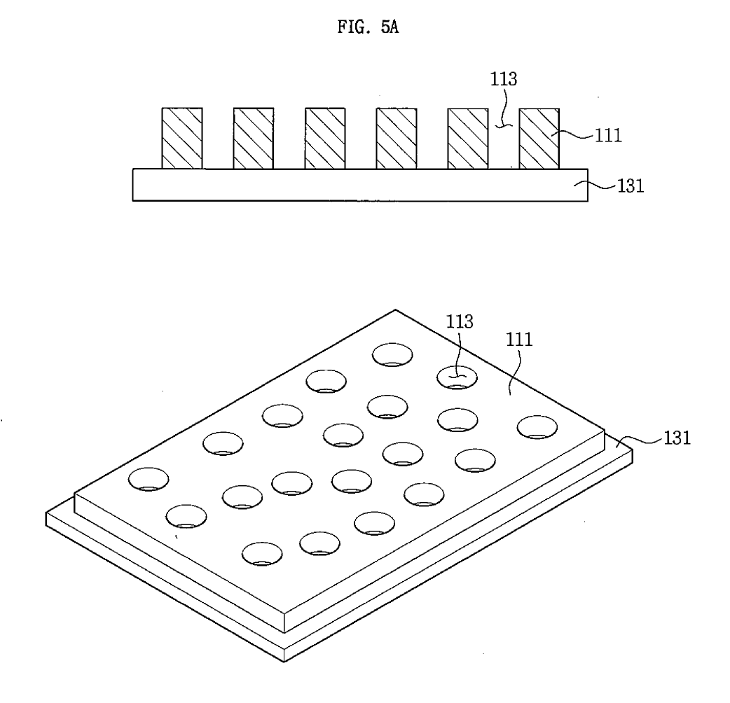

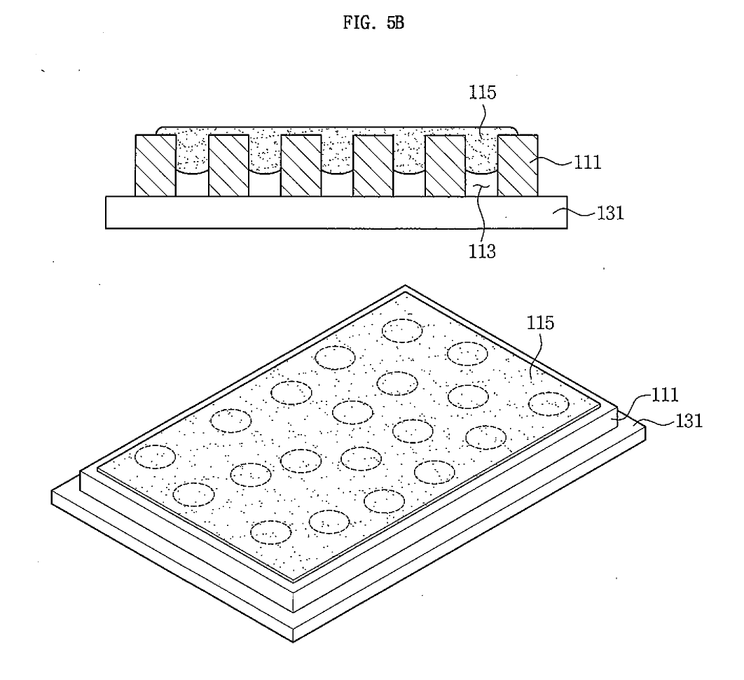

FIG. 2 is a cross-sectional view illustrating a display device to which an adhesive layer 10 is applied; and FIGS. 3 and 4 are cross-sectional views illustrating a functional film 30 to which the adhesive layer 10 is applied.

The adhesive layer 10 may be mainly composed of a PSA. The PSA is an elastic body having a viscoelastic (e.g., a fluid) property.

Such a viscoelastic/fluid property may refer to a behavior of an adhesive material exhibited in a fluid state when a pressure is applied to bond (adhere) the PSA to an adhesive surface of an adherend. Due to the fluid property of the PSA such as liquid, in a case of an external force being applied thereto, the PSA may be deformed or may be pushed sideways. Accordingly, the PSA may be displaced from an initial adhesion position.

Referring to FIG. 2, when the display device which is flexible is folded, a display panel 20 including a substrate, a light emitting element, and the like, the functional film 30, and the like, may be bent together therewith. In this instance, a stress may be applied to the substrate, and a restoring force for releasing the stress and returning the display device to an initial position thereof may occur. The functional film 30 may include a polarizing film 31, a touch sensor 33, and a window 35. In a case in which a flexible display device remains in a deformed state for a long period of time, in order to release a stress applied throughout the entire or substantially the entire display device, processes illustrated in FIGS. 3 and 4 may be performed in a combination thereof.

Referring to FIG. 3, when opposite forces that are parallel to one another are applied to the polarizing film 31 and the touch sensor 33, respectively, the adhesive layer 10 may be deformed.

Accordingly, adhesion positions of the polarizing film 31 and the touch sensor 33 may be displaced due to a restoring force within the adhesive layer 10 for returning the adhesive layer 10 to an initial shape thereof.

Referring to FIG. 4, when compression forces are applied to adhesion surfaces of the adhesive layer 10 which are bonded to the polarizing film 31 and the touch sensor 33, respectively, during a set or predetermined period of time the adhesive layer 10 may escape from both ends of each of the polarizing film 31 and the touch sensor 33.

In addition, even subsequent to the compression force being removed, the adhesive layer 10 may remain thinner than earlier (e.g., prior to the compression force being applied), and a buckling phenomenon, which refers to a separation occurring on an adhesive surface, may occur.

Referring to FIG. 1, the adhesive layer 110 according to the example embodiment may include the adhesive 115 solidified in or within the pore 113, and thereby deformation such as a shearing deformation of the adhesive layer 110 may be prevented (or a likelihood or amount of such deformation may be reduced) even in the case of an external force being applied to the adhesive layer 110. Accordingly, errors or defects in the adhesive layer 110 according to the example embodiment caused by the shear deformation or the buckling phenomenon may be reduced and damage to an organic light emitting display unit including the adhesive layer 110 may be reduced.

A method of manufacturing the porous adhesive film 100 according to the example embodiment may include: preparing a lower release film; attaching a porous adhesive sheet having a pore to the lower release film; forming an adhesive layer by coating an adhesive on to the porous adhesive sheet; and curing the adhesive using a light source.

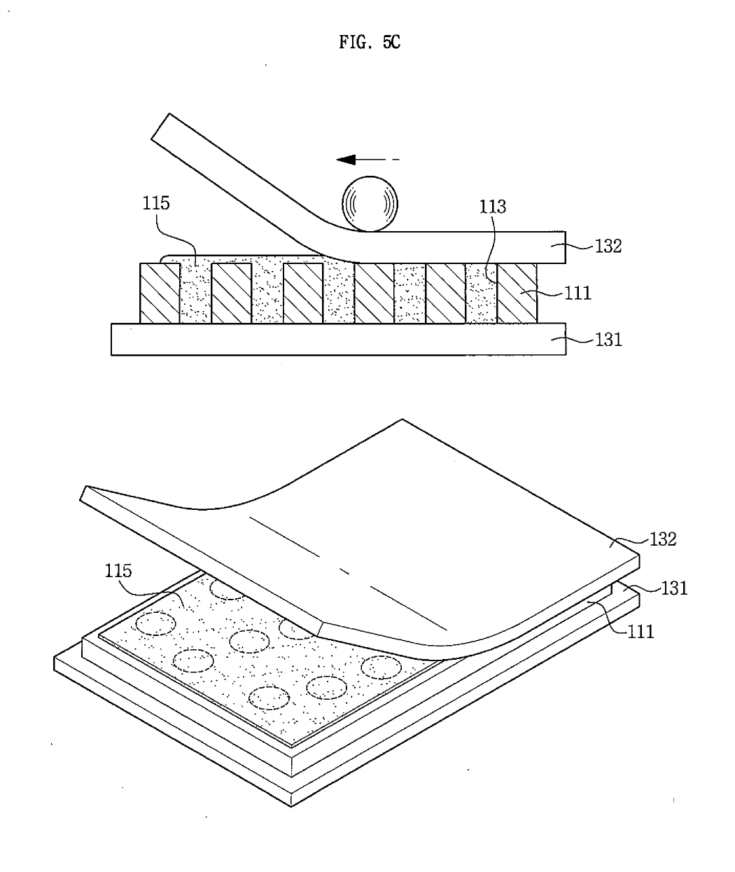

Hereinafter, the method of manufacturing the porous adhesive film 100 according to the example embodiment will be described with reference to FIGS. 5A through 5D.

FIGS. 5A through 5D are schematic views illustrating sequential processes of the method of manufacturing the porous adhesive film 100 according to the example embodiment.

Referring to FIG. 5A, the lower release film 131 is prepared, and the porous adhesive sheet 111 having the pore 113 is attached to the lower release film 131.

Referring to FIG. 5B, the adhesive 115 is coated on to the porous adhesive sheet 111 to thereby form the adhesive layer 110.

The adhesive 115 may use, for example, a curable liquid adhesive, and may have a viscosity in a range of about 1 cP to about 5000 cP. A scheme of coating the adhesive 115 may include an inkjet printing scheme, a slit coating scheme, or a screen printing scheme, but the present disclosure is not limited thereto. In a case in which the viscosity of the adhesive 115 is in a range of about 1 cP to about 100 cP, the inkjet printing scheme may be suitable or appropriate, and beyond the aforementioned range of viscosity (e.g., in a range of 100 cP to 5000 cP), the slit coating scheme or the screen printing scheme may be suitable or appropriate.

In this instance, in a case of using an adhesive sheet having a pore filled with the adhesive 115 in advance (e.g., prior to the porous adhesive sheet 111 being attached to the lower release film 131) as the porous adhesive sheet 111, the process of coating the adhesive on to the adhesive sheet may be omitted.

Referring to FIG. 5C, subsequent to the forming of the adhesive layer 110, the upper release film 132 is attached to the adhesive layer 110 to oppose (face) the lower release film 131.

Referring to FIG. 5D, subsequent to the attaching of the upper release film 132, the adhesive 115 is cured (e.g., by using a light source).

In some embodiments, heat or UV light may be used as the light source for the curing. For example, a light emitting diode (“LED”) lamp that emits UV light having a long wavelength of about 385 nanometers (nm) may be used for the curing.

For example, the curing of the adhesive 115 may be performed by irradiating a UV light having a wavelength in a range of about 380 nm to about 390 nm on to the adhesive 115. In this instance, such a UV light is irradiated upwardly from the upper release film 132 to be transmitted therethrough. The UV light is irradiated on to the pore 113 filled with the adhesive 115 and an entire or substantially entire coating layer of the adhesive 115.

The coating layer of the adhesive 115 is cured into an inner portion thereof (e.g., an inner portion of the porous adhesive sheet 111) by the light irradiation, such that the adhesive layer 110 is formed. Since the cured adhesive 115 serves to maintain a shape of the adhesive layer 110, in a case of an external force being applied to the adhesive layer 110, deformation of the adhesive layer 110 such as a shear deformation may be prevented (or a likelihood or amount of such deformation may be reduced).

Through the aforementioned processes illustrated in FIGS. 5A through 5D, the porous adhesive film 100 having excellent adhesion and rigidity is manufactured according to embodiments of the present disclosure.

Since the adhesive layer 110, the porous adhesive sheet 111, the pore 113, the adhesive 115, and the release film′130 used in the above processes are the same as those corresponding components included in the porous adhesive film 100 of FIG. 1, a repeated detailed description thereof is not necessary and will not be repeated here for the sake of conciseness.

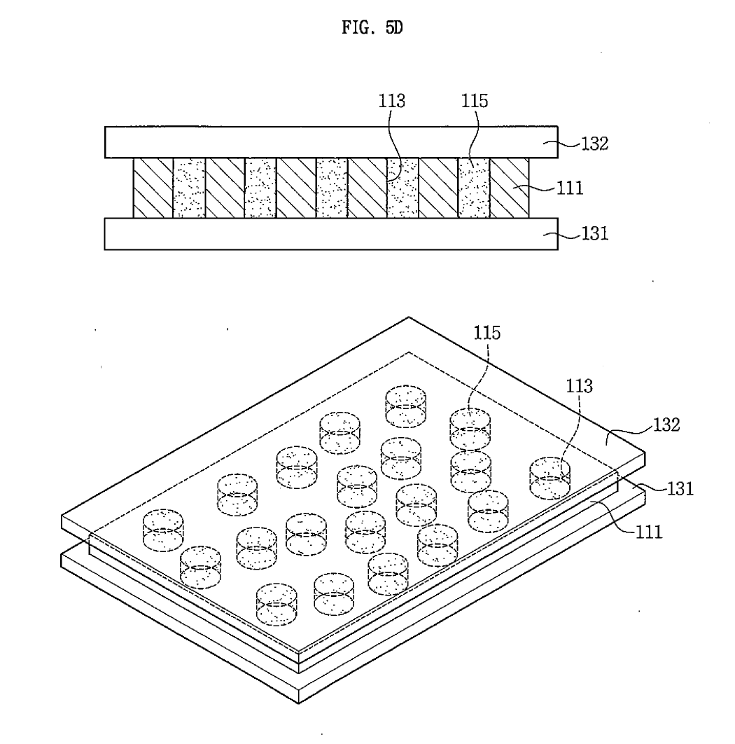

Hereinafter, a method of manufacturing a porous adhesive film according to another example embodiment will be described with reference to FIGS. 6A through 6D.

FIGS. 6A through 6D are schematic cross-sectional views illustrating sequential processes of a method of manufacturing the porous adhesive film according to the other example embodiment, respectively.

In the present example embodiment, a porous adhesive sheet 111 may be a polymer sheet having a void (pore) 113 which is arbitrarily (randomly) distributed therein. The method of manufacturing the porous adhesive film according to the present example embodiment may be the same or substantially the same as that previously described with reference to FIGS. 5A through 5D, aside from using the polymer sheet (e.g., aside from the structural differences between the porous adhesive sheets 111). Accordingly, the same reference numeral may be used for the polymer sheet as that of the porous adhesive sheet 111 for ease of description and understanding of the configuration of the adhesive layer 110.

Since a polymer chain has at least an end (a terminal end) in almost all known polymers, a free volume, which refers to a void (pores), is included within the polymer. In a process of manufacturing the polymer, a size of the void is adjusted by adding an additive, and the like, thereinto. According to embodiments of the present disclosure, a curable liquid adhesive is injected into the void of the polymer to thereby form an adhesive layer and form a mechanical anchoring between the adhesive layer and upper and lower adhesive surfaces of respective adherends thereabove and therebelow, such that a shear deformation of the adhesive layer is prevented (or a likelihood or amount of such shear deformation is reduced).

The method of manufacturing the porous adhesive film according to the present example embodiment may include: attaching the polymer sheet 111 having the void 113 to a lower release film 131 (refer to FIG. 6A); coating a liquid adhesive 115 on to the polymer sheet 111 and injecting the liquid adhesive 115 thereinto to form the adhesive layer 110 (refer to FIGS. 6B and 6C); and attaching an upper release film 132 to the polymer sheet 111 into which the liquid adhesive 115 is injected and curing the liquid adhesive 115 (e.g., by using UV light; refer to FIG. 6D).

Referring to FIG. 6B, the coating of the liquid adhesive 115 on to the polymer sheet 111, and the injecting of the liquid adhesive 115 into the polymer sheet 111 are illustrated. In some embodiments, those coating and injecting processes may be performed by an act or scheme of immersing the polymer sheet 111 in the liquid adhesive 115.

A display device according to an example embodiment may include: a display panel; an adhesive layer disposed on a surface of the display panel; and a window disposed on the adhesive layer. The adhesive layer may include a porous adhesive sheet having a pore; and an adhesive filled in the pore. The display device may further include a second adhesive layer on a second surface of the display panel, and a protection layer may be on the second adhesive layer.

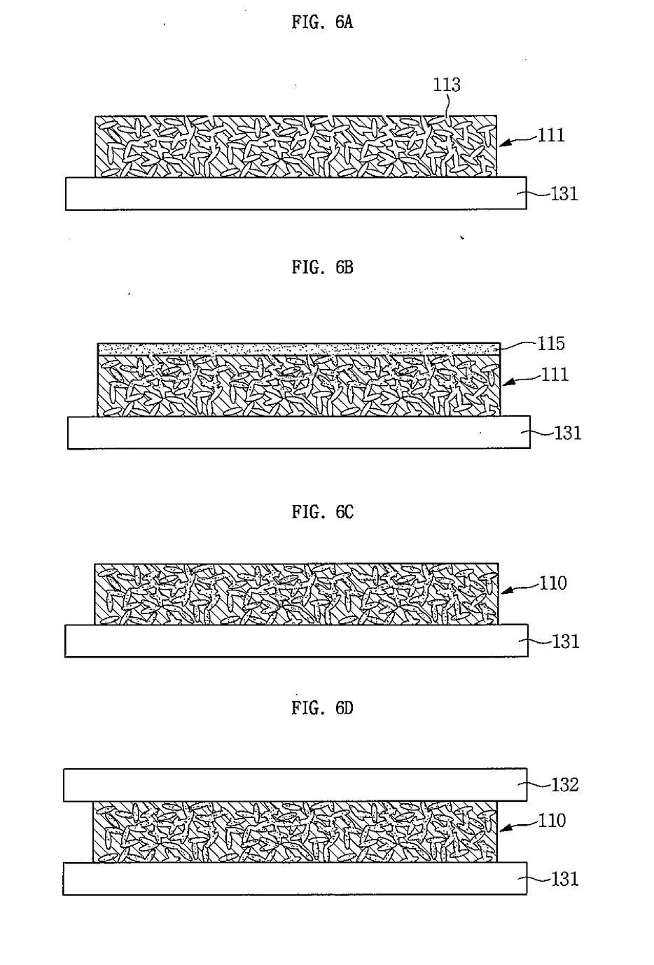

FIG. 7 is a cross-sectional view illustrating an example in which the adhesive layer 110 of the porous adhesive film 100 illustrated in FIG. 1 is applied to a display device 1000.

Referring to FIG. 7, the display device 1000 may include a display panel 200 which is foldable as is an organic light emitting diode (“OLED”) display device, and the adhesive layer 110 attached to an image display surface of the display panel 200.

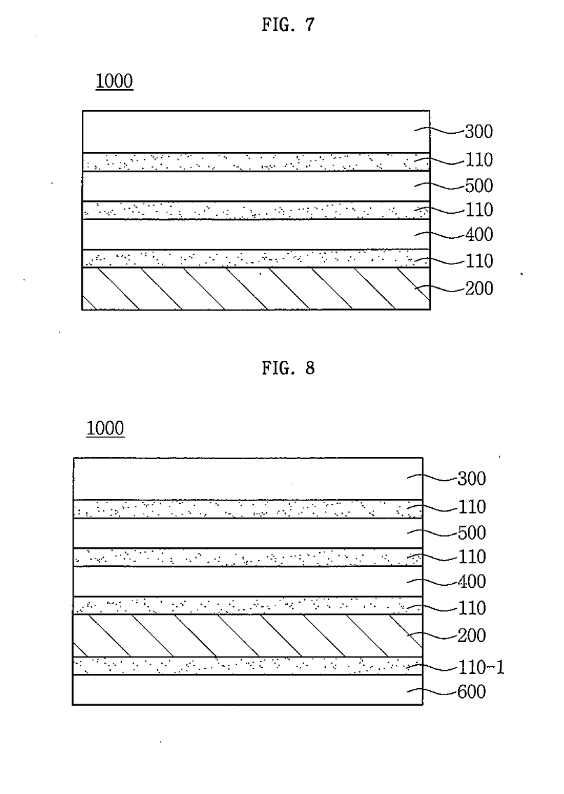

Referring to FIG. 8, the display device 1000 may further include a second adhesive layer 110-1 on a second surface of display panel 200, and a protection layer 600 on the second adhesive layer.

According to the present example embodiment, the porous adhesive film 100 may be attached to the display panel 200 in a state in which the release film 130 is removed (or has been removed) from the porous adhesive film 100. In some embodiments, the release film 130 may be attached to the display panel 200, along with the porous adhesive film 100 being attached to the display panel 200.

As previously described, through the use of the porous adhesive film 100 having high adhesion and rigidity, the display device 1000 may repeatedly perform the folding and unfolding thereof without or substantially without concerns regarding modification of the adhesive layer 110 or displacement of the adhesion position of the adhesive layer 110.

The display device 1000 may include the display panel 200, the adhesive layer 110 disposed on the display panel 200, and a window 300 disposed on the adhesive layer 110.

The display panel 200 may be a liquid crystal panel, or an organic light emitting panel. A polarizing film 400 for preventing or reducing reflection of external light may be disposed on the display panel 200. In addition, a touch sensor 500 may be disposed on the polarizing film 400. In some embodiments, the polarizing film 400 and the touch sensor 500 may be omitted herein.

The display device 1000 may include the porous adhesive film 100 described with reference to FIG. 1. Accordingly, components of the display device 1000 that are the same as or correspond to those of the porous adhesive film 100 are given the same reference numeral as the corresponding components, and a repeated description pertaining to the porous adhesive film 100 is not necessary and will not be repeated here for the sake of conciseness.

A method of manufacturing the display device 1000 using the porous adhesive film 100 according to the example embodiment may be similar to any suitable method of manufacturing a display device generally available in the art, except that the display device may include the adhesive layer 110 interposed between the components constituting the display device 1000 includes the porous adhesive sheet 111 and the adhesive 115 which is filled in the pore 113.

Since the method of manufacturing the adhesive layer 110, which is a different feature from that of other display devices, is described with reference to FIGS. 5A through 5D and FIGS. 6A through 6D, a more detailed description pertaining to the method of manufacturing the display device 1000 is not necessary and will not be repeated here for the sake of conciseness.

As set forth above, according to one or more example embodiments, the porous adhesive film including the adhesive sheet having the pore and the adhesive layer composed of the adhesive filled in the pore may be provided.

The porous adhesive film may have excellent adhesion, and may prevent or reduce deformation of the adhesive layer and displacement of the adhesion position of the adhesive layer.

In addition, the porous adhesive film may be applied to a display device such as, for example, a flexible display device, so as to enable high damage resistance against the repeated folding and unfolding thereof for a relatively long period of time.

From the foregoing, it will be appreciated that various embodiments in accordance with the present disclosure have been described herein for purposes of illustration, and that various modifications may be made without departing from the scope and spirit of the present disclosure. Accordingly, the various embodiments disclosed herein are not intended to be limiting of the true scope and spirit of the present disclosure. Various features of the above described and other embodiments can be mixed and matched in any suitable manner, to produce further embodiments consistent with the present disclosure.

What is claimed is:

1. A porous adhesive film comprising:
an adhesive layer; and
a release film on at least a surface of the adhesive layer,
wherein the adhesive layer comprises:
a porous adhesive sheet comprising a pore; and
an adhesive in the pore.

2. The porous adhesive film of claim 1, wherein the adhesive layer has a shear modulus in a range of about 100 megapascals (MPa) to about 1000 MPa.

3. The porous adhesive film of claim 1, wherein the pore has a size in a range of about 0.5 micrometers (μm) to about 500 μm.

4. The porous adhesive film of claim 1, wherein the adhesive has a viscosity in a range of about 1 centipoise (cP) to about 5000 cP.

5. A method of manufacturing a porous adhesive film, the method comprising:
preparing a lower release film; and
disposing an adhesive layer on the lower release film,
wherein the disposing of the adhesive layer comprises:
attaching a porous adhesive sheet comprising a pore to the lower release film;
disposing an adhesive in the pore of the porous adhesive sheet; and
curing the adhesive.

6. The method of claim 5, further comprising disposing an upper release film on the adhesive layer to face the lower release film, prior to the curing of the adhesive.

7. The method of claim 5, wherein the adhesive layer has a shear modulus in a range of about 100 megapascals (MPa) to about 1000 MPa.

8. The method of claim 5, wherein the pore has a size in a range of about 0.5 micrometers (μm) to about 500 μm.

9. The method of claim 5, wherein the adhesive has a viscosity in a range of about 1 centipoise (cP) to about 5000 cP.

10. A display device comprising:
a display panel;
a first adhesive layer on a first surface of the display panel; and
a window on the first adhesive layer,
wherein the first adhesive layer comprises:
a porous adhesive sheet comprising a pore; and
an adhesive in the pore.

11. The display device of claim 10, further comprising:
a second adhesive layer on a second surface of the display panel; and
a protection layer on the second adhesive layer.

12. The display device of claim 10, wherein the first adhesive layer has a shear modulus in a range of about 100 megapascals (MPa) to about 1000 MPa.

13. The display device of claim 10, wherein the pore has a size in a range of about 0.5 micrometers (μm) to about 500 μm.

14. The display device of claim 10, wherein the display panel comprises an organic light emitting diode.
